(19) United States
(12) Patent Application Publication
(10) Pub. No.: US 2024/0331945 A1
(43) Pub. Date: Oct. 3, 2024

(54) MULTILAYER CERAMIC ELECTRONIC DEVICE

(71) Applicant: TAIYO YUDEN CO., LTD., Tokyo (JP)

(72) Inventors: Takashi ASAI, Tokyo (JP); Yoichi KATO, Tokyo (JP); Tomoyasu EGUCHI, Tokyo (JP)

(73) Assignee: TAIYO YUDEN CO., LTD., Tokyo (JP)

(21) Appl. No.: 18/617,235

(22) Filed: Mar. 26, 2024

(30) Foreign Application Priority Data
Mar. 31, 2023 (JP) 2023-058916

(51) Int. Cl. H01G 4/232; H01G 4/30

(52) U.S. Cl. CPC H01G 4/2325; H01G 4/30

(57) ABSTRACT

A multilayer ceramic electronic device includes an element body and external electrodes. At least one of the pair of external electrodes includes a first metal layer and a second metal layer. The first metal layer covers a part of internal electrodes and a first portion of cover dielectric layers and side margin sections which is located on a side of the internal electrodes, does not cover a second portion of the cover dielectric layers and the side margin section which is other than the first portion, contacts a part of the internal electrodes, and has a main component of nickel or copper, at a corresponding end face of the element body. The second metal layer covers the first metal layer, contacts at least a part of the second portion on a side of the first metal layer, and has a main component of tin.

### CROSS-REFERENCE TO RELATED APPLICATION

This application is based upon and claims the benefit of priority of the prior Japanese Patent Application No. 2023-058916, filed on Mar. 31, 2023, the entire contents of which are incorporated herein by reference.

### FIELD

A certain aspect of the present disclosure relates to a multilayer ceramic electronic device.

### BACKGROUND

In multilayer ceramic electronic devices such as multilayer ceramic capacitors, it is known to provide an uncovered area where an internal nickel electrode layer is not covered by an external nickel electrode layer, and to provide an external copper electrode layer in the uncovered area (for example, Japanese Patent Application Publication No. 2022-14532). A structure in which the external electrode does not cover the side surface of the side margin portion is known (for example, Japanese Patent Application Publication No. 2017-195359).

### SUMMARY OF THE INVENTION

According to an aspect of the embodiments, there is provided a multilayer ceramic electronic device including: an element body including a multilayer body in which a plurality of internal electrodes and a plurality of dielectric layers are alternately stacked in a first direction, a pair of cover dielectric layers sandwiching the multilayer body in the first direction, and a pair of end faces facing each other in a second direction to which the plurality of internal electrodes are alternately exposed, the plurality of dielectric layers including a pair of side margin sections sandwiching the plurality of internal electrodes in a third direction orthogonal to the first direction and the second direction; and a pair of external electrodes respectively covering each of the pair of end faces, wherein at least one of the pair of external electrodes includes a first metal layer and a second metal layer, wherein the first metal layer covers a part of the plurality of internal electrodes and a first portion of the pair of cover dielectric layers and the pair of side margin sections which is located on a side of the plurality of internal electrodes, does not cover a second portion of the pair of cover dielectric layers and the pair of the side margin section which is other than the first portion, contacts a part of the plurality of internal electrodes, and has a main component of nickel or copper, at a corresponding end face of the element body, and wherein the second metal layer covers the first metal layer, contacts at least a part of the second portion on a side of the first metal layer, and has a main component of tin.

According to another aspect of the embodiments, there is provided a multilayer ceramic electronic device including: an element body including a multilayer body in which a plurality of internal electrodes and a plurality of dielectric layers are alternately stacked in a first direction, a pair of cover dielectric layers sandwiching the multilayer body in the first direction, and a pair of end faces facing each other in a second direction to which the plurality of internal electrodes are alternately exposed, the plurality of dielectric layers including a pair of side margin sections sandwiching the plurality of internal electrodes in a third direction orthogonal to the first direction and the second direction; and a pair of external electrodes respectively covering each of the pair of end faces, wherein at least one of the pair of external electrodes includes a first metal layer and a second metal layer, wherein the first metal layer covers a part of the plurality of internal electrodes and a first portion of the pair of cover dielectric layers and the pair of side margin sections which is located on a side of the plurality of internal electrodes, does not cover a second portion of the pair of cover dielectric layers and the pair of the side margin section which is other than the first portion, and contacts a part of the plurality of internal electrodes, at a corresponding end face of the element body, and wherein the second metal layer covers the first metal layer, contacts at least a part of the second portion on a side of the first metal layer, and has a Young's modulus smaller than that of the first metal layer.

### BRIEF DESCRIPTION OF THE DRAWINGS

FIG. 1 is a partially sectional perspective view of a multilayer ceramic capacitor according to an embodiment;

FIG. 2 is a cross-sectional view taken along a line A-A in FIG. 1;

FIG. 3 is a cross-sectional view taken along a line B-B in FIG. 1;

FIG. 4 is a diagram of a first surface of FIG. 1 seen through an external electrode;

FIG. 5 is a diagram of a second surface of FIG. 1 seen through an external electrode;

FIG. 6 is a cross-sectional view corresponding to an A-A cross section in FIG. 1 of a multilayer ceramic capacitor of a comparative object 1;

FIG. 7 is a cross-sectional view corresponding to an A-A cross section in FIG. 1 of a multilayer ceramic capacitor of a comparative object 2;

FIG. 8A and FIG. 8B are diagrams when multilayer ceramic capacitors of comparative objects 1 and 2 are mounted on a mounting board;

FIG. 8C is a diagram of a multilayer ceramic capacitor of an embodiment mounted on a mounting board;

FIG. 9 is a diagram of a first surface of a multilayer ceramic capacitor of a comparative object 3, seen through an external electrode;

FIG. 10 is a flowchart of an example of a manufacturing process of a multilayer ceramic capacitor;

FIG. 11A to FIG. 11C are cross-sectional views of a method for manufacturing a multilayer ceramic capacitor according to an embodiment;

FIG. 12A to FIG. 12C are cross-sectional views of a method for manufacturing a multilayer ceramic capacitor according to an embodiment;

FIG. 13A to FIG. 13D are cross-sectional views of various examples of external electrodes in an embodiment; and

FIG. 14 is a diagram of a first surface of FIG. 13B seen through an external electrode.

### DETAILED DESCRIPTION

When a multilayer ceramic electronic device is mounted on a mounting board, if stress is concentrated at the end where the external electrode contacts the element body, problems such as cracks in the element body or peeling of the external electrodes may occur.

Hereinafter, an exemplary embodiment will be described with reference to the accompanying drawings.

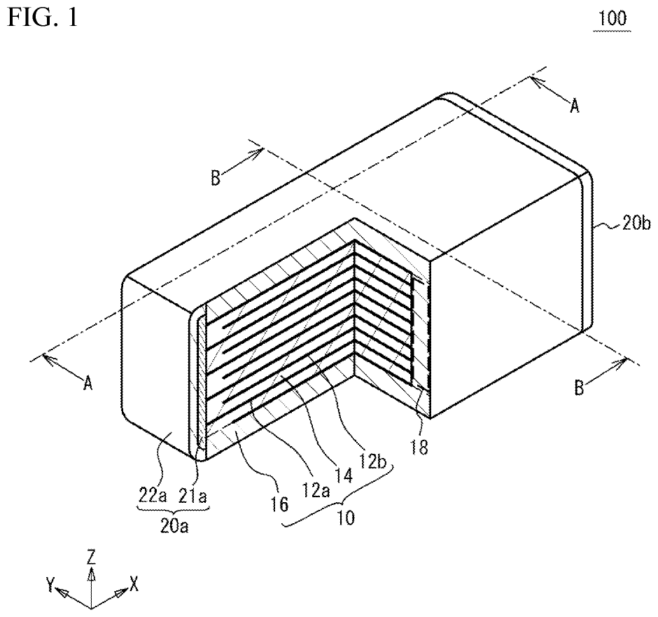

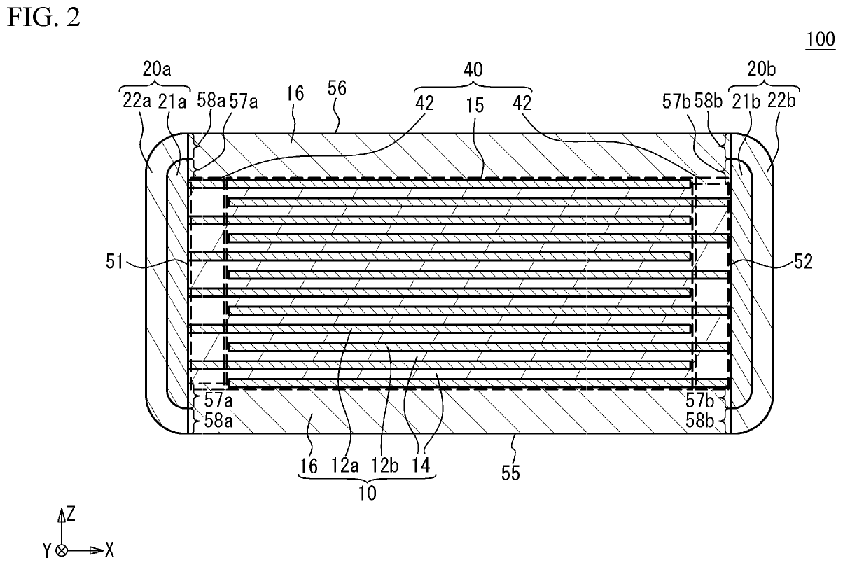

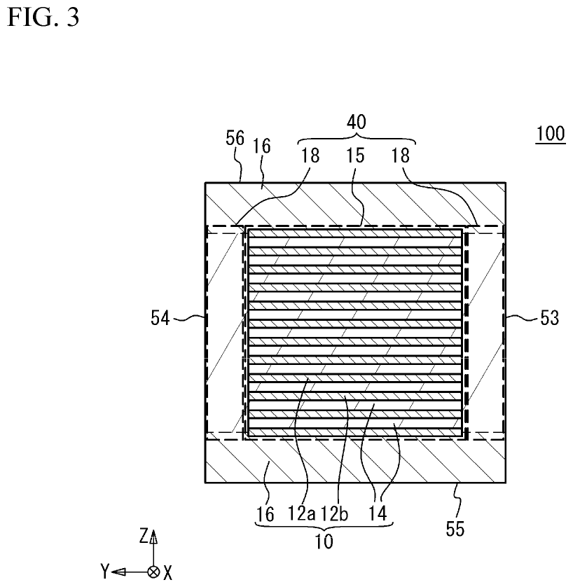

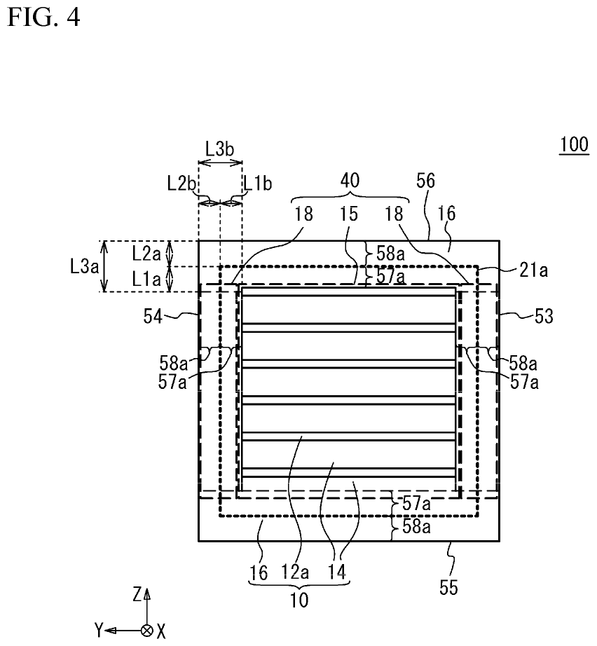

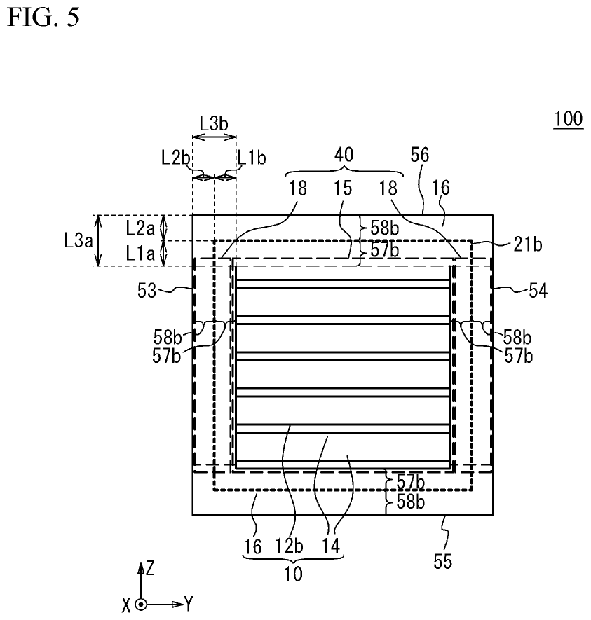

(Embodiment) FIG. 1 is a partially sectional perspective view of a multilayer ceramic capacitor 100 according to an embodiment. FIG. 2 is a cross-sectional view taken along a line A-A in FIG. 1. FIG. 3 is a cross-sectional view taken along a line B-B in FIG. 1. FIG. 4 is a diagram of a first surface of FIG. 1 seen through the external electrode. FIG. 5 is a diagram of a second surface of FIG. 1 seen through the external electrode. In FIG. 4 and FIG. 5, regions where metal layers 21a and 21b are provided are indicated by thick dotted lines.

In FIG. 1 to FIG. 5, a Z direction (first direction) is a stacking direction in which dielectric layers 14 and internal electrodes 12a and 12b are stacked, and a fifth surface 55 and a sixth surface 56 of an element body 10 face each other. An X direction (second direction) is a length direction of the element body 10, and is the direction in which a first surface 51 and a second surface 52 of the element body 10 face each other. A Y direction (third direction) is a width direction of the internal electrodes 12a and 12b, and is the direction in which a third surface 53 and a fourth surface 54 of the element body 10 face each other. The X direction, the Y direction, and the Z direction are orthogonal to each other.

The multilayer ceramic capacitor 100 includes the element body 10 having a substantially rectangular parallelepiped shape, and external electrodes 20a and 20b.

The element body 10 has the plurality of dielectric layers 14, the plurality of internal electrodes 12a and 12b, and cover dielectric layers 16. The plurality of internal electrodes 12a and the plurality of internal electrodes 12b are alternately stacked in the Z direction. One of the plurality of dielectric layers 14 is provided between one of the plurality of internal electrodes 12a and one of the plurality of internal electrodes 12b. The outermost layers in the stacking direction (Z direction) of a multilayer body 40 in which the dielectric layer 14 and the internal electrodes 12a and 12b are stacked are the internal electrodes 12a and 12b. The pair of cover dielectric layers 16 are provided to sandwich the multilayer body 40 in the Z direction of the multilayer body 40. A section where the internal electrodes 12a and 12b face each other with the dielectric layer 14 in between is a capacity section 15. The sections sandwiching the capacity section 15 in the X direction of the element body 10 in FIG. 2 are a pair of end margin sections 42. The sections sandwiching the capacity section 15 in the Y direction in FIG. 3 to FIG. 5 are a pair of side margin sections 18.

The internal electrodes 12a and 12b are alternately exposed on the first surface 51 and the second surface 52. The internal electrodes 12a are exposed from the first surface 51, but the internal electrodes 12b are not exposed from the first surface 51. The internal electrodes 12b are exposed from the second surface 52, but the internal electrodes 12a are not exposed from the second surface 52. That is, each of the internal electrodes 12a and 12b is connected to each of the different one of the first surface 51 and the second surface 52.

As illustrated in FIG. 2, FIG. 4, and FIG. 5, the external electrodes 20a (and 20b) (a pair of external electrodes) include the metal layer 21a (and 21b) (first metal layer) and a metal layer 22a (and 22b) (second metal layer). On the first surface 51 (and the second surface 52), a portion that surrounds the internal electrode 12a (and 12b) and is located on the side of the internal electrodes 12a (and 12b) of the cover dielectric layer 16 and the side margin section 18 is a portion 57a (and 57b) (first portion). A portion of the cover dielectric layer 16 and the side margin section 18 other than the portion 57a (and 57b) is a portions 58a (and 58b) (second portions). The metal layer 21a (and 21b) contacts the internal electrode 12a (and 12b), covers and contacts the portion 57a (and 57b), respectively, and does not cover the portion 58a (and 58b), respectively.

The metal layer 22a (and 22b) covers the metal layer 21a (and 21b) and covers and contacts the portion 58a (and 58b) at the first surface 51 (and the second surface 52). The metal layer 22a (and 22b) is not provided on the third surface 53 and the fourth surface 54.

The size of the multilayer ceramic capacitor 100 is, for example, a length (length in the X direction) of 0.25 mm, a width (width in the Y direction) of 0.125 mm, and a height (height in the Z direction) of 0.125 mm, or 0.4 mm in length, 0.2 mm in width, and 0.2 mm in height, or 0.6 mm in length, 0.3 mm in width, and 0.3 mm in height, or 1.0 mm in length, 0.5 mm in width, and 0.5 mm in height, or 3.2 mm in length, 1.6 mm in width, and 1.6 mm in height, or 4.5 mm in length, 3.2 mm in width, and 2.5 mm in height. The size of the multilayer ceramic capacitor 100 is not to limited to these sizes.

The width of the side margin section 18 in the Y direction is, for example, 10 μm to 30 μm. The length of the end margin section 42 in the X direction is, for example, 10 μm to 50 μm.

The internal electrodes 12a and 12b are mainly composed of base metals such as nickel (Ni), copper (Cu), or tin (Sn). As the internal electrodes 12a and 12b, noble metals such as platinum (Pt), palladium (Pd), silver (Ag), or gold (Au), or alloys containing these metals may be used. The thickness of the internal electrodes 12a and 12b is, for example, 0.1 μm or more and 1 μm or less.

The dielectric layer 14 has, for example, a ceramic material having a perovskite structure represented by the general formula ABO₃ as a main phase. Note that the perovskite structure includes ABO_{3-α} that deviates from the stoichiometric composition. For example, the ceramic materials is at least one of barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr₂O₃ (0≤x≤1, 0≤y≤1, 0≤z≤1). Ba_{1-x-y}CaₓSr_{y}Ti_{1-z}Zr₂O₃ is such as barium strontium titanate, barium calcium titanate, barium zirconate, barium zirconate titanate, calcium zirconate titanate, and barium calcium zirconate titanate. For example, the dielectric layer 14 contains 90 atomic percent or more of ceramic as the main component. The thickness of the dielectric layer 14 is, for example, 2 μm or more and 5 μm or less.

Additives may be added to the dielectric layer 14. Additives to the dielectric layer 14 may be an oxide of such as zirconium (Zr), hafnium (Hf), magnesium (Mg), manganese (Mn), molybdenum (Mo), vanadium (V), chromium (Cr), or a rare earth elements (Y (yttrium), samarium (Sm), europium (Eu), gadolinium (Gd), terbium (Tb), dysprosium (Dy), holmium (Ho), erbium (Er), thulium (Tm) and ytterbium (Yb)) or oxides containing cobalt (Co), nickel (Ni), lithium (Li), boron (B), sodium (Na), potassium (K) or silicon (Si), or a glass containing cobalt, nickel, lithium, boron, sodium, potassium or silicon.

The composition of the main component ceramic of the cover dielectric layer 16 may be the same as or different from the main component ceramic of the dielectric layer 14. The side margin section 18 may be a side dielectric layer different from the dielectric layer 14. In this case, the composition of the main component ceramic of the side dielectric layer may be the same as or different from that of the main component ceramic of the dielectric layer 14.

The metal layers 21a and 21b of the external electrodes 20a and 20b are mainly made of metals such as copper, nickel, aluminum (Al), and Zn (zinc), or an alloy of two or more of these (for example, an alloy of copper and nickel). The metal layers 21a and 21b may contain a glass component for densifying the metal layers 21a and 21b. When firing the metal layers 21a and 21b, a ceramic such as a co-material for controlling the sinterability of the metal layers 21a and 21b is included. The glass component is an oxide of barium (Ba), strontium (Sr), calcium (Ca), zinc, aluminum, silicon, or boron. The co-material is, for example, a ceramic component whose main component is the same material as the main component of the dielectric layer 14.

In the external electrodes 20a and 20b, the metal layers 22a and 22b contain tin or the like as a main component. The metal layers 22a and 22b are softer than the metal layers 21a and 21b. That is, the Young's modulus of the metal layers 22a and 22b is smaller than the Young's modulus of the metal layers 21a and 21b.

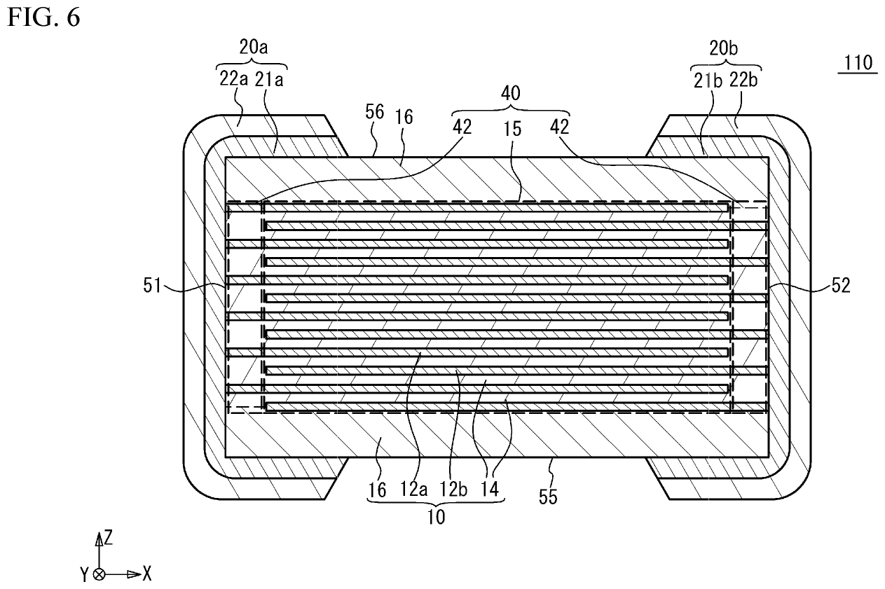

FIG. 6 is a cross-sectional view corresponding to the A-A cross section in FIG. 1 of the multilayer ceramic capacitor of a comparative object 1. As illustrated in FIG. 6, in the multilayer ceramic capacitor 110 of the comparative object 1, the external electrode 20a is provided at each end of the first surface 51, the third surface 53, the fourth surface 54, the fifth surface 55, and the sixth surface 56. The external electrode 20b is provided at each end of the second surface 52, the third surface 53, the fourth surface 54, the fifth surface 55, and the sixth surface 56. The metal layers 22a and 22b are respectively provided on the metal layers 21a and 21b. The metal layers 22a and 22b are not provided in contact with the first surface 51 and the second surface 52, respectively.

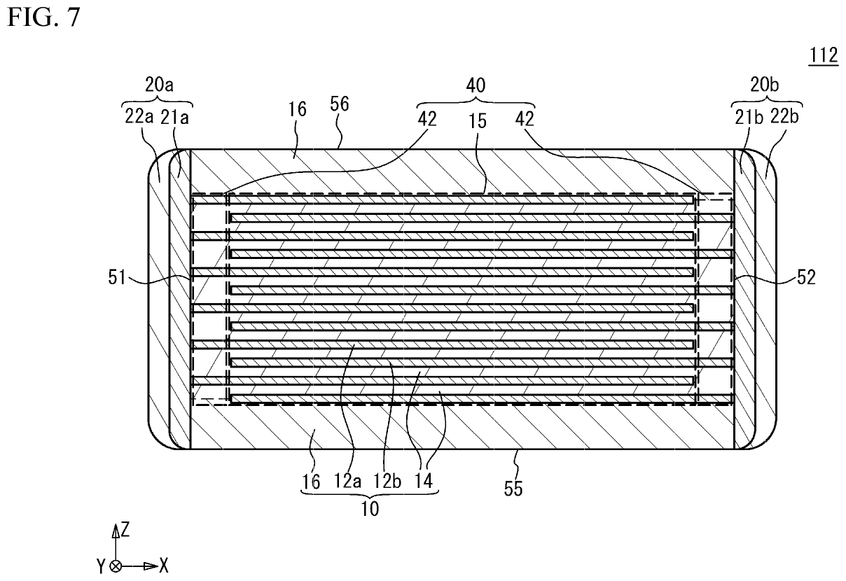

FIG. 7 is a cross-sectional view corresponding to the A-A cross section in FIG. 1 of the multilayer ceramic capacitor of a comparative object 2. As illustrated in FIG. 7, in a multilayer ceramic capacitor 112 of the comparative object 2, the external electrodes 20a and 20b are respectively provided on the first surface 51 and the second surface 52, and are not provided on the third surface 53, the fourth surface 54, the fifth surface 55 and the sixth surface 56. The metal layers 21a and 21b are provided on the entire first surface 51 and the entire second surface 52, and the metal layers 22a and 22b are provided in contact with the first surface 51 and the second surface 52 outside of the metal layers 21a and 21b.

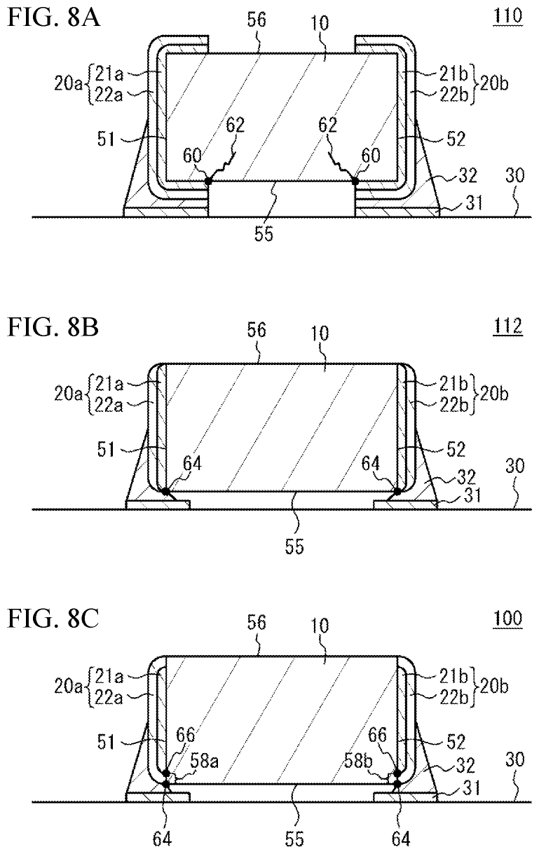

FIG. 8A and FIG. 8B are diagrams when the multilayer ceramic capacitors of the comparative objects 1 and 2 are mounted on a mounting board, and FIG. 8C is a diagram of the multilayer ceramic capacitor of the embodiment mounted on a mounting board. As illustrated in FIG. 8A, the multilayer ceramic capacitor 110 of comparative object 1 is mounted on a land 31 on a mounting board 30. The external electrodes 20a and 20b and the land 31 are joined by a joining material 32 such as solder. When thermal stress is applied to the element body 10 due to the difference in linear expansion coefficient between the mounting board 30 and the element body 10, the stress is concentrated at end portions 60 of the external electrodes 20a and 20b on the fifth surface 55. This may cause cracks 62 to occur in the element body 10.

As illustrated in FIG. 8B, in the multilayer ceramic capacitor 112 of the comparative 2, the external electrodes 20a and 20b are not provided on the fifth surface 55, so stress concentration on the fifth surface 55 of the element body 10 is reduced. However, end portions 64 where the external electrodes 20a and 20b contact the first surface 51 are the ends of the metal layers 21a and 21b. Since the metal layers 21a and 21b are hard metals, if stress is concentrated at the portions 64, the metal layers 21a and 21b may peel off from the element body 10.

As illustrated in FIG. 8C, in the multilayer ceramic capacitor 100, the metal layers 22a and 22b cover the portions 58a and 58b of the first surface 51 and the second surface 52 that are not covered by the metal layers 21a and 21b. The metal layers 22a and 22b are softer than the metal layers 21a and 21b. Therefore, even if stress is concentrated at the portion 64, the metal layers 22a and 22b are less likely to peel off from the element body 10 than in the multilayer ceramic capacitor 112 of the comparative object 2. Since stress is less likely to be concentrated at portions 66 at the ends of the metal layers 21a and 21b than at the portions 64, the metal layers 21a and 21b are less likely to peel off from the element body 10.

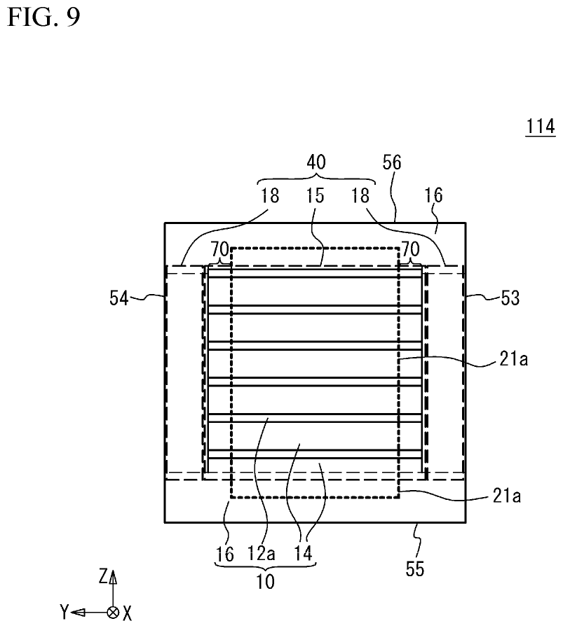

FIG. 9 is a diagram of the first surface of the multilayer ceramic capacitor of a comparative object 3, seen through the external electrode. The region where the metal layer 21a is provided is indicated by a thick broken line. As illustrated in FIG. 9, in a multilayer ceramic capacitor 114 of the comparative object 3, the metal layer 21a does not cover an end region 70 of the internal electrode 12a in the Y direction. Thereby, the metal layer 22a contacts the internal electrode 12a in the region 70. If the contact resistance between the metal layer 22a and the internal electrode 12a is high, the contact resistance between the external electrode 20a and the internal electrode 12a will be high.

As illustrated in FIG. 4 and FIG. 5, in the multilayer ceramic capacitor 100 of the embodiment, the metal layers 21a and 21b contact the internal electrodes 12a and 12b and cover the portions 57a and 57b. Thereby, the contact resistance between the external electrode 20a and the internal electrode 12a can be reduced.

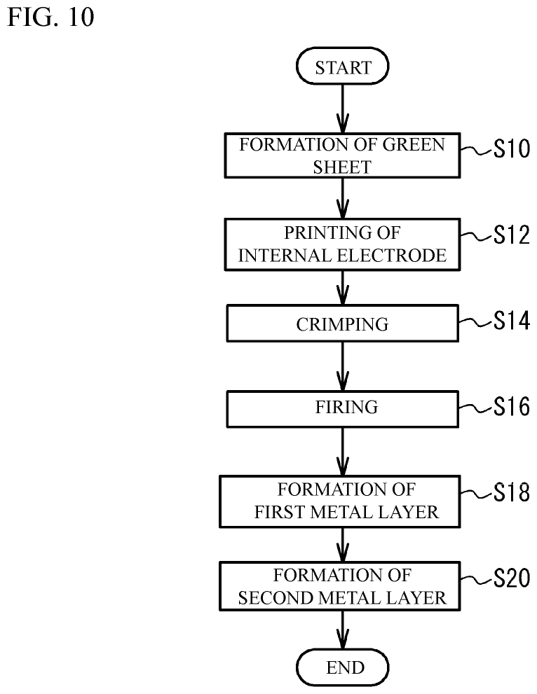

(Manufacturing method of multilayer ceramic capacitor) A method for manufacturing the multilayer ceramic capacitor 100 will be described. FIG. 10 is a flowchart of an example of the manufacturing process of a multilayer ceramic capacitor.

(Green sheet forming process) First, a green sheet is formed (step S10). In step S10, for example, a dielectric material obtained by adding various additive compounds (sintering aids, and so on) to ceramic powder is mixed with a binder such as polyvinyl butyral (PVB) resin and an organic solvent such as ethanol or toluene and a plasticizer are added and wet mixed. Using the obtained slurry, a green sheet is coated onto a substrate using, for example, a die coater method or a doctor blade method, and then dried. The base material is, for example, a PET (polyethylene terephthalate) film.

(Internal electrode printing process) Next, internal electrodes are printed on the green sheet (step S12). In step S12, a metal conductive paste for forming internal electrodes containing an organic binder is printed on the green sheet on the base material using, for example, a gravure printing method. As a result, a plurality of internal electrode patterns corresponding to the internal electrodes 12a and 12b are formed on the green sheet while being separated from each other. Ceramic particles are added to the metal conductive paste as a co-material. Although the main component of the ceramic particles is not particularly limited, it is preferable that the main component is the same as the main component ceramic of the dielectric layer 14.

(Crimp process) Subsequently, the green sheets are stacked and pressed together (step S14). In step S14, a multilayer sheet is formed by stacking green sheets on which internal electrode patterns to become the internal electrodes 12a and 12b are printed. Green sheets corresponding to the cover dielectric layer 16 are stacked on both end faces of the stacked sheet in the stacking direction. Subsequently, the plurality of green sheets are crimped together by applying pressure to the multilayer sheet. As the crimping means, for example, a hydrostatic press is used. Subsequently, a plurality of the element bodies 10 are formed by cutting the multilayer sheet along predetermined cut lines in the stacking direction using a cutting blade.

(Firing process) Subsequently, the element body 10 is fired (step S16). In step S16, the element body 10 is subjected to a binder removal treatment in a nitrogen gas atmosphere at 250° C. to 500° C., and then fired at 1300° C. to 1400° C. for about 1 hour in a reducing atmosphere. As a result, each grain in the element body 10 and side dielectric layers 18a and 18b is sintered.

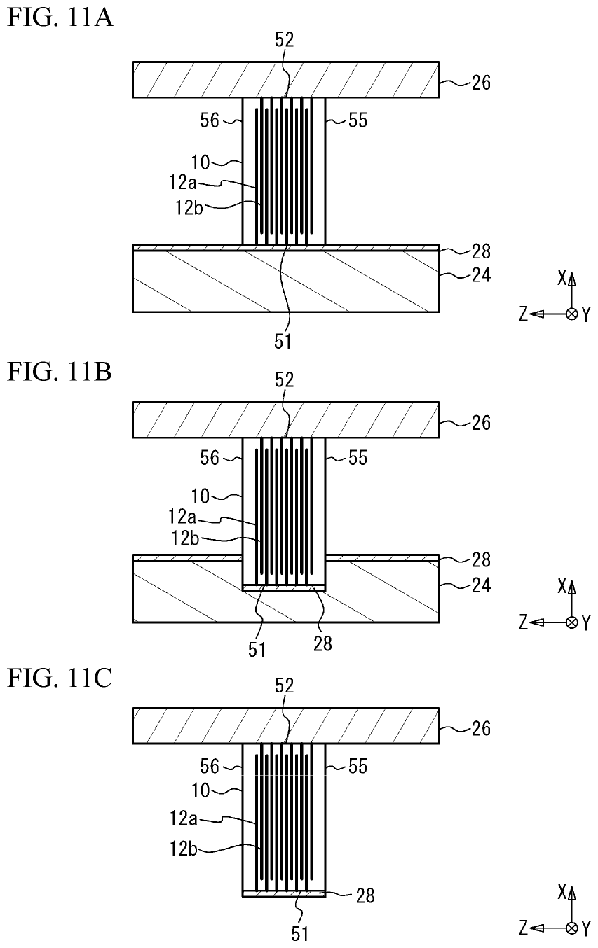

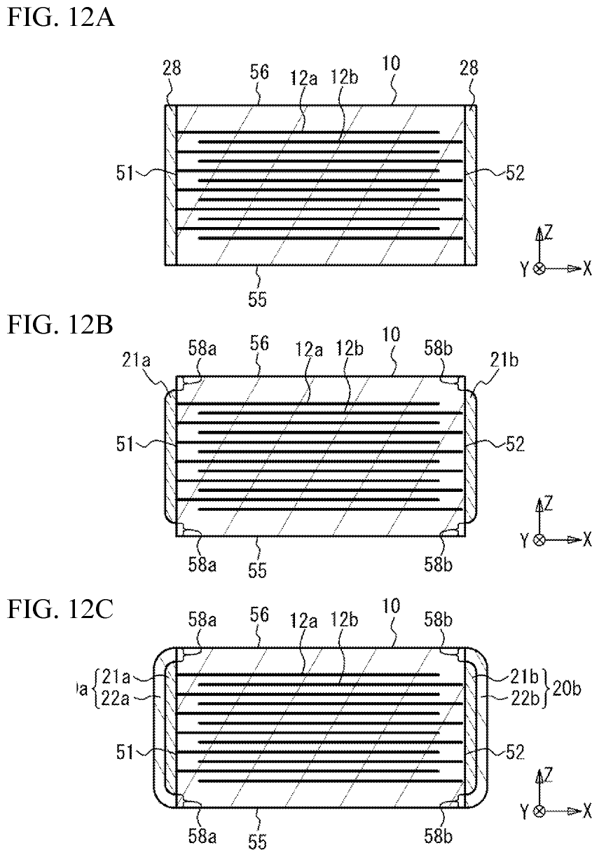

(First metal layer formation step) Subsequently, the metal layers 21a and 21b are formed (step S18). Step S18 will be described below with reference to FIG. 11A to FIG. 12B.

FIG. 11A to FIG. 12C are cross-sectional views of a method for manufacturing a multilayer ceramic capacitor according to an embodiment. As illustrated in FIG. 11A, a metal sheet 28 is placed on a flat elastic body 24. The metal sheet 28 is arranged to cover the first surface 51. A tape 26 is pasted onto the second surface 52 of the element body 10.

Subsequently, as illustrated in FIG. 11B, the tape 26 is pressed downward (in the −X direction) by a pressing device (not illustrated). As a result, the first surface 51 of the element body 10 is pressed against the surface of the metal sheet 28. At this time, the pressed portion of the metal sheet 28 is depressed by the pressure from the element body 10, and the elastic body 24 below the element body 10 is also depressed. The recessed portion of the metal sheet 28 is pressed against the first surface 51 of the element body 10 by the restoring force from the elastic body 24. As a result, a portion of the metal sheet 28 sticks to the first surface 51. At this time, the metal sheets 28 are stuck along the corners of the element body 10 at both ends of the first surface 51 in the stacking direction (Z direction). Thereafter, when the pressing force of the element body 10 increases, a shearing force is generated between the stuck part of the metal sheet 28 and the other parts, so that the stuck part and the other parts are separated from each other.

Subsequently, as illustrated in FIG. 11C, the tape 26 is moved upward (in the +X direction) by a pressing device (not illustrated). As a result, the element body 10 moves away from the elastic body 24. At this time, the separated portion of the metal sheet 28 sticks to the first surface 51 of the element body 10.

Subsequently, the metal sheet 28 is attached to the second surface 52 of the element body 10 in the same manner as in FIG. 11A to FIG. 11C. As illustrated in FIG. 12A, the metal sheet 28 is attached to the entire surface of the first surface 51 and the second surface 52.

Subsequently, barrel polishing is performed as illustrated in FIG. 12B. As a result, the outer portion of the metal sheet 28 is polished, and the metal sheet 28 at the peripheral portions 58a and 58b of the first surface 51 and the second surface 52 is removed, forming the metal layers 21a and 21b. At this time, the corners of the element body 10 may be polished and the corners of the element body 10 may be rounded. By selecting the barrel polishing conditions, the metal sheet 28 can be polished more than the element body 10.

(Second metal layer forming step) Subsequently, the metal layers 22a and 22b are formed (step S20). Step S20 will be described below with reference to FIG. 12C.

As illustrated in FIG. 12C, the metal layers 22a and 22b are formed on the surfaces of the metal layers 21a and 21b by plating the surfaces of the metal layers 21a and 21b. By appropriately selecting plating conditions, the metal layers 22a and 22b can be formed also on the end faces of the metal layers 21a and 21b, thereby forming the metal layers 22a and 22b in contact with the portions 58a and 58b. By appropriately selecting the plating time, the metal layers 22a and 22b can cover the entire surfaces of the portions 58a and 58b. After forming a thin seed layer on the surfaces of the metal layers 21a and 21b and the portions 58a and 58b by electroless plating or sputtering, the metal layers 22a and 22b may be formed on the surfaces of the seed layers by plating.

The metal layers 21a and 22a form the external electrode 20a, and the metal layers 21b and 22b form the external electrode 20b.

(Another example of external electrode formation process) Before the step of firing the element body 10 in step S16 of FIG. 10, a paste is applied as the metal sheet 28 to the first surface 51 and the second surface 52, as illustrated in FIG. 12A. Subsequently, firing in step S16 in FIG. 10 is performed. As illustrated in FIG. 12B, the metal sheet 28 contracts, and the portions 58a and 58b that are not covered by the metal layers 21a and 21b are formed at the peripheral edges of the first surface 51 and the second surface 52. Subsequently, the metal layers 22a and 22b are formed as illustrated in FIG. 12C. The external electrodes 20a and 20b may be formed in this manner. The method for forming the external electrodes 20a and 20b is not limited to the above method.

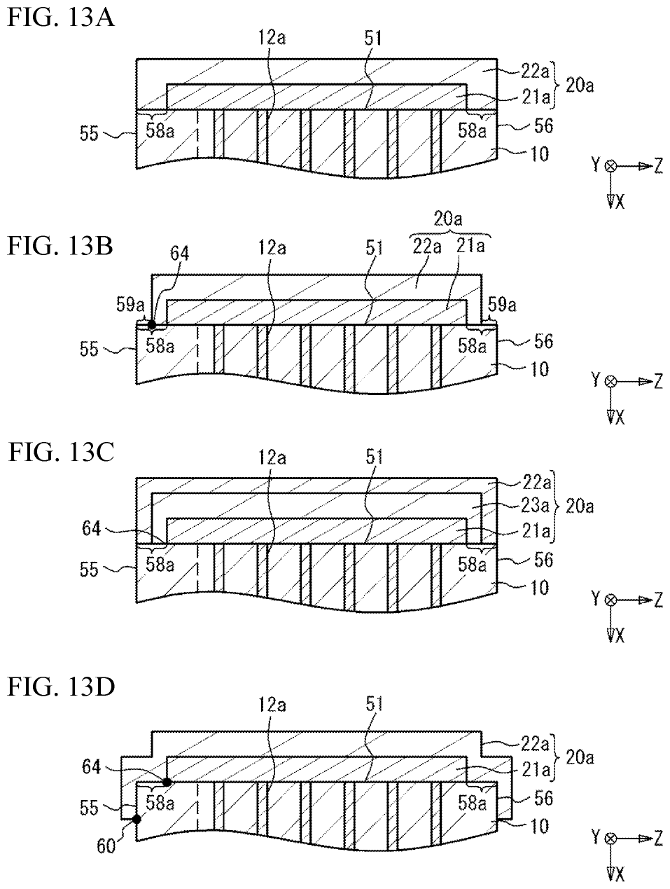

(Example of external electrode) FIG. 13A to FIG. 13D are cross-sectional views of various examples of external electrodes in the embodiment. As illustrated in FIG. 13A, the metal layer 22a (and 22b) may completely cover the portion 58a (and the portion 58b).

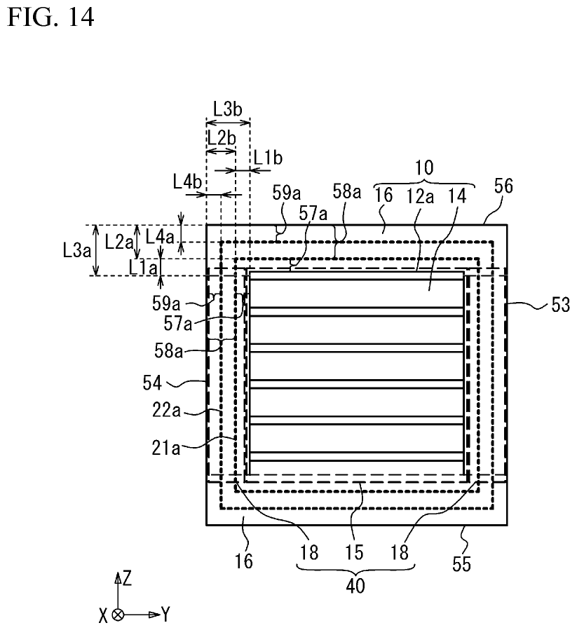

FIG. 14 is a diagram of the first surface of FIG. 13B seen through the external electrode. The regions covered by the metal layers 21a and 22a are indicated by thick dotted lines. As illustrated in FIG. 13B and FIG. 14, the metal layer 22a (and 22b) may cover the inner portion of the portion 58a (and the portion 58b) and may not necessarily cover the outer portion 59a. In this case as well, since the soft metal layer 22a (and 22b) and the element body 10 are in contact with each other at the end portion 64 of the external electrode 20a (and 20b) where the stress is most concentrated, the metal layer 22a (and 22b)) can be suppressed from peeling off from the element body 10.

As illustrated in FIG. 13C, a metal layer 23a may be provided between the metal layer 22a (and 22b) and the metal layer 21a (and 21b). It is sufficient that the outermost metal layers 22a and 22b of the external electrodes 20a (and 20b) are softer than the metal layers 21a and 21b that contact the internal electrodes 12a (and 12b).

As illustrated in FIG. 13D, the metal layer 22a (and 22b) may cover the ends of the fifth surface 55 and the sixth surface 56. In this case as well, since the soft metal layer 22a (and 22b) and the element body 10 are in contact with each other at the end portion 60 of the external electrode 20a (and 20b) where the stress is most concentrated, the metal layer 22a (and 22b)) can be suppressed from peeling off from the element body 10. Furthermore, the occurrence of the cracks 62 as illustrated in FIG. 8A can be suppressed. Furthermore, since the end portions 64 of the metal layers 21a (and 21b) are not provided at the corners of the element body 10, stress concentration at the portions 64 can be suppressed.

In FIG. 13A to FIG. 13D, the internal electrodes 12a (and 12b) have nickel as a main component, for example. The metal layer 21a (and 21b) has nickel or copper as a main component, for example. The metal layer 22a (and 22b) has tin as a main component, for example. The metal layer 23a is provided as a diffusion barrier layer when, for example, the metal layer 21a (and 21b) has copper as the main component and the metal layer 22a (and 22b) has tin as the main component, and the metal layer 23a has nickel as the main component.

As described above, in the embodiment, as illustrated in FIG. 2 and FIG. 4, the metal layer 21a (and 21b) covers the portion 57a (and 57b) but does not cover the portion 58a (and 58b). The metal layer 22a (and 22b) has a Young's modulus smaller than that of the metal layer 21a (and 21b), covers the metal layer 21a (and 21b), and covers at least a portion of the portion 58a (and 58b) on the metal layer 21a (and 21b) side in the first surface 51 (and the second surface 52). Thereby, as illustrated in FIG. 8C, defects such as cracks in the element body 10 or peeling of the external electrodes 20a and 20b can be suppressed. From the viewpoint of suppressing defects, the Young's modulus of the metal layer 22a (and 22b) is preferably ¾ or less, more preferably ½ or less, of the Young's modulus of the metal layer 21a (and 21b). The metal layers 21a and 21b are in contact with the entirety of internal electrodes 12a and 12b exposed on the first surface 51 and the second surface 52, respectively. Thereby, the contact resistance between the external electrodes 20a and 20b and the internal electrodes 12a and 12b can be reduced.

Soft metals have a low Young's modulus. The Young's moduli of nickel, copper and tin are 204 GPa, 130 GPa and 41 GPa, respectively. Therefore, the metal layers 21a and 21b have nickel or copper as the main component, and the metal layers 22a and 22b have tin as the main component. The metal layers 21a and 21b may contain a co-material such as nickel or copper. The metal layers 22a and 22b may be made of tin-based solder such as tin-silver-copper solder or tin-silver solder. Here, the main component allows other elements or compounds to be added intentionally or unintentionally, and for example, the content is 50 atomic % or more, 80 atomic % or more, and 90 atomic %. That's all.

As illustrated in FIG. 13D, the metal layers 22a and 22b of the external electrodes 20a and 20b may cover the ends of the third surface 53, the fourth surface 54, the fifth surface 55, and the sixth surface 56. However, the multilayer ceramic capacitor may become larger. Therefore, as illustrated in FIG. 13A to FIG. 13C, the external electrodes 20a (and 20b) do not cover surfaces other than the first surface 51 (and the second surface 52) of the element body 10. This allows the multilayer ceramic capacitor to be miniaturized.

As illustrated in FIG. 13A, the metal layer 22a (and 22b) may cover the first surface 51 (and the second surface 52) to the end, or as illustrated in FIG. 13B, the metal layer 22a (and 22b) does not need to cover at least a portion 59a (third portion) of the peripheral edge of the first surface 51 (and the second surface 52).

In FIG. 4 and FIG. 5, if the areas of the portions 58a and 58b are too large, when the alignment between the metal layers 21a and 21b and the internal electrodes 12a and 12b is misaligned, the internal electrodes 12a and 12b may be exposed from the metal layers 21a and 21b. From this viewpoint, the area of the portion 58a is preferably 9/10 or less, more preferably ⅘ or less of the total area of the portion 57a and the portion 58a. The area of the portion 58b is preferably 9/10 or less, more preferably ⅘ or less of the total area of the portions 57b and 58b.

If the areas of the portions 58a and 58b are too small, the end portions 66 of the metal layers 21a and 21b (see FIG. 8C) may be close to the end portions 64 of the first surface 51 and the second surface 52. In this case, stress concentration at the portion 66 becomes large, and there is a possibility that the metal layers 21a and 21b may peel off from the element body 10. From this viewpoint, the area of the portion 58a is preferably 1/10 or more, more preferably ⅕ or more of the total area of the portion 57a and the portion 58a. The area of the portion 58b is preferably 1/10 or more, more preferably ⅕ or more of the total area of the portions 57b and 58b.

As illustrated in FIG. 4 and FIG. 5, the width of the portions 57a and 57b in the side margin section 18 in the Y direction is L1b, the width of the portions 58a and 58b in the Y direction is L2b, and the width of the side margin section 18 in the Y direction is L3b. The width of the portions 57a and 57b in the cover dielectric layer 16 in the Z direction is L1a, the width of the portions 58a and 58b in the Z direction is L2a, and the width of the cover dielectric layer 16 in the Z direction is L3a.

From the viewpoint of not exposing the internal electrodes 12a (and 12b) from the metal layers 21a (and 21b), the width L1a (and L1b) is preferably 1/10 or more, and more preferably ⅕ or more of the width L3a (and L3b). From the viewpoint of suppressing peeling of the metal layer 21a (and 21b), the width L1a (and L1b) is preferably 9/10 or less, and more preferably ⅘ or less of the width L3a (and L3b), respectively.

In FIG. 14, if the widths L4a and L4b where the metal layer 22a is not provided are large, stress will be concentrated at the ends of the metal layer 21a, and the metal layer 21a will easily peel off from the element body 10. From this viewpoint, the widths L4a and L4b are preferably ½ or less, and more preferably ⅓ or less, of the widths L2a and L2b, respectively. The same applies to the second surface 52.

An example has been described in which both of the pair of external electrodes 20a and 20b include the first metal layers 21a and 21b and the second metal layers 22a and 22b. At least one of the external electrodes 20a and 20b may include the metal layers 21a and 21b and the metal layers 22a and 22b on at least one of the corresponding fifth surface 55 and the sixth surface 56.

Although the embodiments of the present invention have been described in detail, it is to be understood that the various change, substitutions, and alterations could be made hereto without departing from the spirit and scope of the invention.

What is claimed is:

1. A multilayer ceramic electronic device comprising:
an element body including a multilayer body in which a plurality of internal electrodes and a plurality of dielectric layers are alternately stacked in a first direction, a pair of cover dielectric layers sandwiching the multilayer body in the first direction, and a pair of end faces facing each other in a second direction to which the plurality of internal electrodes are alternately exposed, the plurality of dielectric layers including a pair of side margin sections sandwiching the plurality of internal electrodes in a third direction orthogonal to the first direction and the second direction; and
a pair of external electrodes respectively covering each of the pair of end faces,
wherein at least one of the pair of external electrodes includes a first metal layer and a second metal layer,
wherein the first metal layer covers a part of the plurality of internal electrodes and a first portion of the pair of cover dielectric layers and the pair of side margin sections which is located on a side of the plurality of internal electrodes, does not cover a second portion of the pair of cover dielectric layers and the pair of the side margin section which is other than the first portion, contacts a part of the plurality of internal electrodes, and has a main component of nickel or copper, at a corresponding end face of the element body, and
wherein the second metal layer covers the first metal layer, contacts at least a part of the second portion on a side of the first metal layer, and has a main component of tin.

2. The multilayer ceramic electronic device as claimed in claim 1, wherein an area of the first portion is 1/10 or more and 9/10 or less of an area of the second portion.

3. The multilayer ceramic electronic device as claimed in claim 1, wherein the at least one of the pair of external electrodes does not cover other faces other than the corresponding end face of the element body.

4. The multilayer ceramic electronic device as claimed in claim 3, wherein the second metal layer extends an end of the corresponding end face.

5. The multilayer ceramic electronic device as claimed in claim 3, wherein the second metal layer does not cover a third portion which is at least a part of a peripheral portion of the corresponding end face.

6. The multilayer ceramic electronic device as claimed in claim 5, wherein a width of the third portion is ½ or less of a width of the second portion.

7. The multilayer ceramic electronic device as claimed in claim 1, wherein both of the pair of external electrodes have the first metal layer and the second metal layer.

8. A multilayer ceramic electronic device comprising:
an element body including a multilayer body in which a plurality of internal electrodes and a plurality of dielectric layers are alternately stacked in a first direction, a pair of cover dielectric layers sandwiching the multilayer body in the first direction, and a pair of end faces facing each other in a second direction to which the plurality of internal electrodes are alternately exposed, the plurality of dielectric layers including a pair of side margin sections sandwiching the plurality of internal electrodes in a third direction orthogonal to the first direction and the second direction; and
a pair of external electrodes respectively covering each of the pair of end faces,
wherein at least one of the pair of external electrodes includes a first metal layer and a second metal layer,
wherein the first metal layer covers a part of the plurality of internal electrodes and a first portion of the pair of cover dielectric layers and the pair of side margin sections which is located on a side of the plurality of internal electrodes, does not cover a second portion of the pair of cover dielectric layers and the pair of the side margin section which is other than the first portion, and contacts a part of the plurality of internal electrodes, at a corresponding end face of the element body, and
wherein the second metal layer covers the first metal layer, contacts at least a part of the second portion on a side of the first metal layer, and has a Young's modulus smaller than that of the first metal layer.

9. The multilayer ceramic electronic device as claimed in claim 8,
wherein a main component of the first metal layer is nickel or copper, and
wherein a main component of the second metal layer is tin.

10. The multilayer ceramic electronic device as claimed in claim 8, wherein an area of the first portion is 1/10 or more and 9/10 or less of an area of the second portion.

11. The multilayer ceramic electronic device as claimed in claim 8, wherein the at least one of the pair of external electrodes does not cover other faces other than the corresponding end face of the element body.

12. The multilayer ceramic electronic device as claimed in claim 11, wherein the second metal layer extends an end of the corresponding end face.

13. The multilayer ceramic electronic device as claimed in claim 11, wherein the second metal layer does not cover a third portion which is at least a part of a peripheral portion of the corresponding end face.

14. The multilayer ceramic electronic device as claimed in claim 13, wherein a width of the third portion is ½ or less of a width of the second portion.

15. The multilayer ceramic electronic device as claimed in claim 8, wherein both of the pair of external electrodes have the first metal layer and the second metal layer.
